(19) United States
(12) Patent Application Publication
(10) Pub. No.: US 2026/0030792 A1
(43) Pub. Date: Jan. 29, 2026

(54) Systems and methods for identifying objects in an image

(71) Applicant: Canva Pty Ltd, Surry Hills (AU)

(72) Inventors: Sanchit Sanchit, Vienna (AT); Alexander Tack, Vienna (AT)

(73) Assignee: Canva Pty Ltd, Surry Hills (AU)

(21) Appl. No.: 19/249,199

(22) Filed: Jun. 25, 2025

(30) Foreign Application Priority Data
Jul. 23, 2024 (AU) 2024205035

(51) Int. Cl. G06T 11/00; G06V 10/26; G06V 10/764

(52) U.S. Cl. CPC G06T 11/00; G06V 10/273; G06V 10/764; G06V 2201/02

(57) ABSTRACT

Described herein is a computer implemented method including displaying an image on a display and then processing, using one or more processing units, the image to identify one or more primary object regions in the image. The method further includes receiving a first user input selecting a first input image position, determining that the first input image position does not correspond to any primary object region, and in response to determining that the first input image position does not correspond to any primary object region, processing the image based on the first input image position to identify a secondary object region in the image.

### CROSS-REFERENCE TO RELATED APPLICATION

This application is a U.S. Non-Provisional Application that claims priority to Australian Patent Application No. 2024205035, filed Jul. 23, 2024, which is hereby incorporated by reference in its entirety.

### TECHNICAL FIELD

Aspects of the present disclosure are directed to systems and methods for identifying objects in an image.

### BACKGROUND

Various computer applications for editing digital images exist. Generally speaking, such applications allow users to change an image by adding elements (such as lines, shapes and/or text) and/or adding visual effects to an image (such as applying colour schemes, thematic effects, etc.)

Users may also wish to edit a specific object within an image. Traditionally, such objects may be manually observed, defined and selected by the user, for instance by manually defining an area or section of the image where an observed object is located. Such a manual selection process is cumbersome since precise defining or marking of an outline of the area or section of the image where the object is located can be very difficult to carry out accurately. The time-consuming nature of this manual process becomes even greater if large numbers of images and/or images with many objects therein need to be edited.

Background information described in this specification is background information known to the inventors. Reference to this information as background information is not an acknowledgment or suggestion that this background information is prior art or is common general knowledge to a person of ordinary skill in the art.

### SUMMARY

Described herein is a computer implemented method including: displaying an image on a display; processing, using one or more processing units, the image to identify one or more primary object regions in the image; receiving a first user input selecting a first input image position; determining that the first input image position does not correspond to any primary object region; and in response to determining that the first input image position does not correspond to any primary object region, processing the image based on the first input image position to identify a secondary object region in the image.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the drawings:

FIG. 1 is a diagram depicting a system in which various features of the present disclosure may be implemented.

FIG. 2 is a block diagram of a computer processing system configurable to perform various features of the present disclosure.

FIG. 3 depicts an example representation of a graphical user interface.

FIG. 4 depicts operations performed in a method for identifying and selecting objects in an image.

FIG. 5 depicts operations performed in a method for processing an image to identify primary objects and precise primary object regions in an image.

FIG. 6 depicts operations performed in a method for identifying a precise secondary object region corresponding to a secondary object in an image.

FIG. 7 depicts an example image.

FIG. 8 depicts a series of example representations of an image as displayed to a user.

FIG. 9 depicts a series of example representations of an image as displayed to a user.

FIG. 10 depicts a series of user interface examples.

While the description is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present invention as defined by the appended claims.

### DETAILED DESCRIPTION

In the following description numerous specific details are set forth in order to provide a thorough understanding of the present invention. It will be apparent, however, that the present invention may be practiced without these specific details. In some instances, well-known structures and devices are shown in block diagram form in order to avoid unnecessary obscuring.

The present disclosure is directed to systems and methods for identifying objects in an image. In the context of the present specification, reference to an image is reference to a raster image.

As discussed above, computer applications for use in editing digital images are known. Such applications will typically provide mechanisms for a user to edit or modify digital images. This may include selecting and editing specific objects in an image. One way of selecting an object is to manually select an area of the digital image where the object is located and apply an effect to that area of the image. Manual selection of an object may, for example, be done by defining the region of the image that the object occupies. Defining a region may involve brush-type operations (e.g. a user brushing in the region) or by drawing an enclosed shape (e.g. drawing or otherwise marking the edges of the region). Once an object's region is defined, the user may then edit or modify the object to which that region corresponds. This modification may include erasing the selected object (i.e. removing the object from the image), replacing the selected object with some other object, resizing the selected object, or otherwise editing the selected object. Furthermore, a selected object (or the pixels thereof) may be copied and added to another image (or design).

The techniques disclosed herein are described in the context of a design platform that is configured to facilitate various operations concerned with digital designs. In the context of the present disclosure, these operations relevantly include displaying and editing digital images.

A design platform may take various forms. In the embodiments described herein, the design platform is described as a stand-alone platform (e.g. a single application or set of applications that run on a user's computer processing system and perform the techniques described herein without requiring server-side operations). The techniques described herein can, however, be performed (or be adapted to be performed) by a client-server type design platform (e.g. one or more client applications and one or more server applications that interoperate to perform the described techniques).

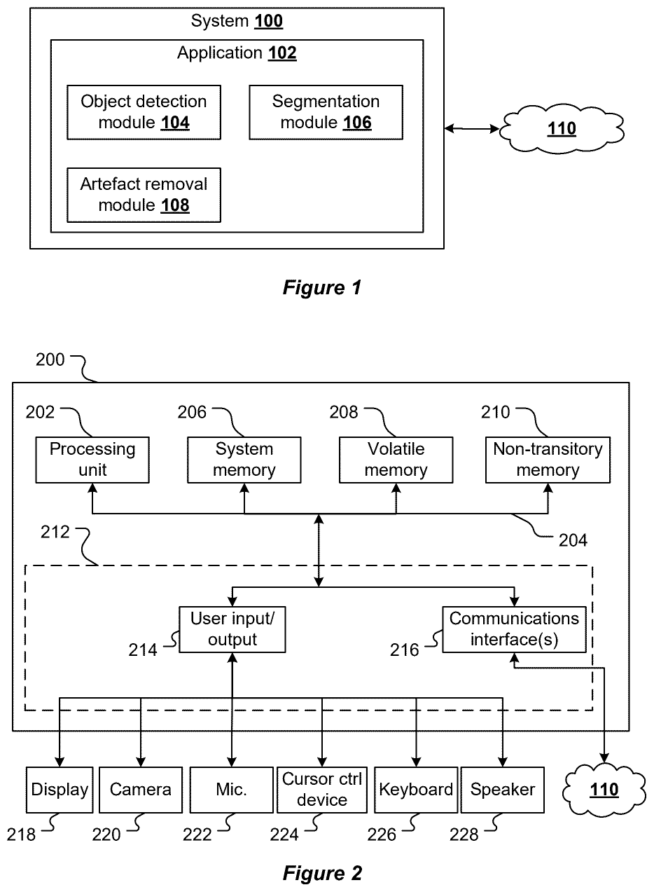

FIG. 1 depicts a computer processing system 100 that is configured to perform the various functions described herein. System 100 may be any suitable type of computer processing system, for example a desktop computer, a laptop computer, a tablet device, a smart phone device, or an alternative computer processing system.

In this example, computer system 100 is configured to perform the functions described herein by execution of an image editing software application 102—that is, computer readable instructions that are stored in a storage device (such as non-transitory memory 210 described below) and executed by a processing unit of the system 100 (such as processing unit 202 described below).

In the present example, application 102 (and/or other applications of system 100) facilitates various functions related to editing digital images. These functions may be facilitated by application 102 generating an user interface and co-ordinating processing of inputs from a user via that user interface. In the present example, application 102 includes modules that handle specific processing steps, in particular an object detection module 104, a segmentation module 106, and an artefact removal module 108. These modules and their specification functionality will be described in detail further below.

In embodiments where a client-server architecture is utilised, one or more of the modules may be provided as (or part of) a remote application (e.g. a service provided by a server that the application interacts with by way of network 110).

Along with image editing, the various functions facilitated by application 102 may include, for example, image (and design) storage, organisation, searching, retrieval, viewing, sharing, publishing, and/or other functions related to digital designs and digital images. Such functions may be provided by application 102 and/or by other modules running on system 100 or an alternative system.

In the example of FIG. 1, system 100 is connected to a communications network 110. Via network 110, system 100 can communicate with (e.g. send data to and receive data from) other computer processing systems (not shown). The techniques described herein can, however, be implemented on a stand-alone computer system that does not require network connectivity or communication with other systems.

In FIG. 1, system 100 is depicted as having/executing a single application 102. However, system 100 may (and typically will) include additional applications (not shown). For example, and assuming application 102 is not part of an operating system application, system 100 will include separate operating system application (or group of applications).

Turning to FIG. 2, a block diagram depicting hardware component of a computer processing system 200 is provided. The computer processing system 100 of FIG. 1 may be a computer processing system such as 200 (though alternative hardware architectures are possible).

Computer processing system 200 includes at least one processing unit 202. Processing unit 202 may be a single computer processing device (e.g. a central processing unit, graphics processing unit, or other computational device), or may include a plurality of computer processing devices. In some instances, where a computer processing system 200 is described as performing an operation or function all processing required to perform that operation or function will be performed by processing unit 202. In other instances, processing required to perform that operation or function may also be performed by remote processing devices accessible to and useable by (either in a shared or dedicated manner) system 200.

Through a communications bus 204 the processing unit 202 is in data communication with a one or more machine readable storage devices (also referred to as memory devices). Computer readable instructions and/or data which are executed by the processing unit 202 to control operation of the processing system 200 are stored on one more such storage devices. In this example system 200 includes a system memory 206 (e.g. a BIOS), volatile memory 208 (e.g. random access memory such as one or more DRAM modules), and non-transitory memory 210 (e.g. one or more hard disk or solid state drives).

System 200 also includes one or more interfaces, indicated generally by 212, via which system 200 interfaces with various devices and/or networks. Other devices may be integral with system 200, or may be separate. Where a device is separate from system 200, connection between the device and system 200 may be via wired or wireless hardware and communication protocols, and may be a direct or an indirect (e.g. networked) connection.

Depending on the particular system in question, devices to which system 200 connects—whether by wired or wireless means—include one or more input devices to allow data to be input into/received by system 200 and one or more output device to allow data to be output by system 200.

By way of example, where system 200 is a personal computing device such as a desktop or laptop device, it may include a display 218 (which may be a touch screen display and as such operate as both an input and output device), a camera device 220, a microphone device 222 (which may be integrated with the camera device), a cursor control device 224 (e.g. a mouse, trackpad, or other cursor control device), a keyboard 226, and a speaker device 228.

As another example, where system 200 is a portable personal computing device such as a smart phone or tablet it may include a touchscreen display 218, a camera device 220, a microphone device 222, and a speaker device 228.

Alternative types of computer processing systems, with additional/alternative input and output devices, are possible.

System 200 also includes one or more communications interfaces 216 for communication with a network, such as network 110 of FIG. 1. Via the communications interface(s) 216, system 200 can communicate data to and receive data from networked systems and/or devices.

System 200 stores or has access to computer applications (also referred to as software or programs)—i.e. computer readable instructions and data which, when executed by the processing unit 202, configure system 200 to receive, process, and output data. Instructions and data can be stored on non-transitory machine-readable medium such as 210 accessible to system 200. Instructions and data may be transmitted to/received by system 200 via a data signal in a transmission channel enabled (for example) by a wired or wireless network connection over an interface such as communications interface 216.

Typically, one application accessible to system 200 will be an operating system application. In addition, system 200 will store or have access to applications which, when executed by the processing unit 202, configure system 200 to perform various computer-implemented processing operations described herein. For example, in FIG. 1 computer processing system 100 (which may be or include the hardware components of computer processing system 200) includes and executes application 102.

In some cases, part or all of a given computer-implemented method will be performed by system 200 itself, while in other cases processing may be performed by other devices in data communication with system 200.

It will be appreciated that FIG. 2 does not illustrate all functional or physical components of a computer processing system. For example, no power supply or power supply interface has been depicted. However, system 200 will either carry a power supply or be configured for connection to a power supply (or both). It will also be appreciated that the particular type of computer processing system will determine the appropriate hardware and architecture, and alternative computer processing systems suitable for implementing features of the present disclosure may have additional, alternative, or fewer components than those depicted.

The present disclosure describes methods and processing as being performed by application 102 utilising object detection module 104, segmentation module 106 and artefact removal module 108. Each of modules 104, 106 and 108 may be software modules such as an add-on or plug-in that operates in conjunction with application 102 to expand the functionality thereof.

Object detection module 104 includes an object detector, for example a trained machine learning model. The machine learning model may be an object detection model that outputs detected objects from an inputted image. In one example, the object detector is a YOLO-V6 COCO trained object detection model as described, for example, in the paper “YOLOv6 v3.0: A Full-Scale Reloading” by Chuyi Li, Lulu Li, Yifei Geng, Hongliang Jiang, Meng Cheng, Bo Zhang, Zaidan Ke, Xiaoming Xu, Xiangxiang Chu (arXiv: 2301.05586). The object detection module 104 may, however, include an alternative object detector (trained on the COCO dataset or one or more alternative training datasets). For example, the object detector may be a DETR model (as described in the paper “End-to-End Object Detection with Transformers” by Nicolas Carion, Francisco Massa, Gabriel Synnaeve, Nicolas Usunier, Alexander Kirillov, Sergey Zagoruyko (arXiv: 2005.12872)), a DINO model (as described in the paper “DINO: DETR with Improved DeNoising Anchor Boxes for End-to-End Object Detection” by Hao Zhang, Feng Li, Shilong Liu, Lei Zhang, Hang Su, Jun Zhu, Lionel M. Ni, Heung-Yeung Shum (arXiv: 2203.03605)), a ConvNext model (as described in the paper “A ConvNet for the 2020s” by Zhuang Liu, Hanzi Mao, Chao-Yuan Wu, Christoph Feichtenhofer, Trevor Darrell, Saining Xie (arXiv: 2201.03545)), a Faster R-CNN model (as described in the paper “Faster R-CNN: Towards Real-Time Object Detection with Region Proposal Networks” by Shaoqing Ren, Kaiming He, Ross Girshick, Jian Sun (arXiv: 1506.01497)), a single-shot detector (SSD) model (as described in the paper “SSD: Single Shot MultiBox Detector” by Wei Liu, Dragomir Anguelov, Dumitru Erhan, Christian Szegedy, Scott Reed, Cheng-Yang Fu, Alexander C. Berg (arXiv: 1512.02325)), an alternative YOLO variant (such as YOLOv1, YOLOv2, YOLOv3, YOLOv8), or an alternative object detection model. As will be appreciated by a person skilled in the art, the object detection model may be selected based on a balance between runtime cost and detection accuracy. Operations performed by the object detection module 104 are described further below.

Segmentation module 106 includes a segmentation model for segmenting an image. As one example, the segmentation model may take the form of a Segment-Anything based segmentation model (SAM), for example the Efficient-Vit-SAM segmentation model as described in the paper “EfficientViT-SAM: Accelerated Segment Anything Model Without Accuracy Loss” by Zhuoyang Zhang, Han Cai, Song Han (arXiv: 2402.05008). In this case, the segmentation model outputs (inter alia) one or more segmentation masks that identify precise object regions (referred to as object regions for convenience) in an inputted image (or a specified portion of an inputted image). In other embodiments, other SAM based models may be used based on application requirements and desired outcomes. For example, Original SAM, Mobile-SAM, Efficient-SAM, or SAM HQ may be used. Further alternatively, the segmentation module 106 may be (or make use of) an alternative (non SAM) segmentation model. Operations performed by the segmentation module 106 are described further below.

In certain embodiments, the artefact removal module 108 operates to identify and (where identified, remove) artefacts from objects that are identified (or, more specifically, from the object regions corresponding to those objects). Operations performed by the artefact removal module 108 are described further below.

In the illustrated embodiment, modules 104, 106 and 108 are described as being part of application 102. In alternative embodiments, the functionality provided by one or more of modules 104, 106 and 108 may be natively provided by application 102 (i.e. client application 102 itself has instructions and data which, when executed, cause application 102 to perform part or all of the functionality described herein). In still further alternative embodiments, one or more of modules 104, 106 and 108 may be a stand-alone application that runs on which communicates with application 102. Further, those one or more stand-alone applications may run on system 100 or run on one or more other systems that communicate with system 100 via network 110.

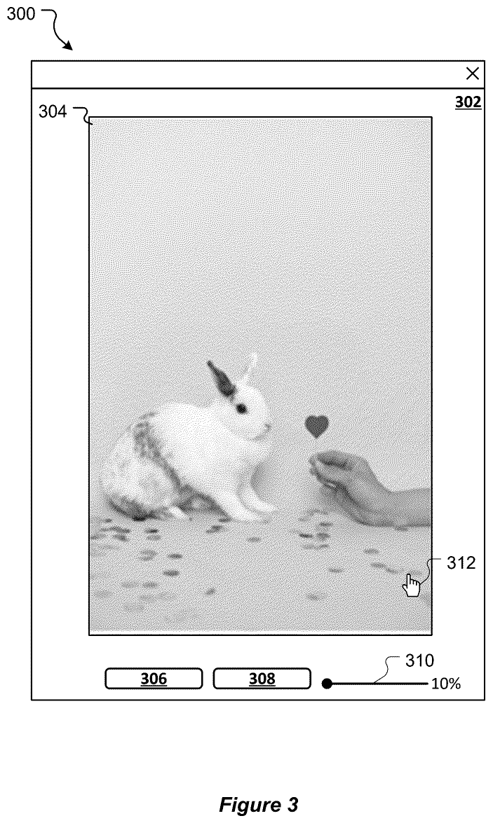

Referring to FIG. 3, in the present disclosure, application 102 configures system 100 to generate and display (e.g. on a touch screen or other display such as 218) an image editor user interface (UI) 300. Generally speaking, UI 300 will allow a user to (inter alia) select, display, edit, and save a digital image. FIG. 3 provides a simplified and partial example of a user interface. In this example UI 300 is a graphical user interface (GUI).

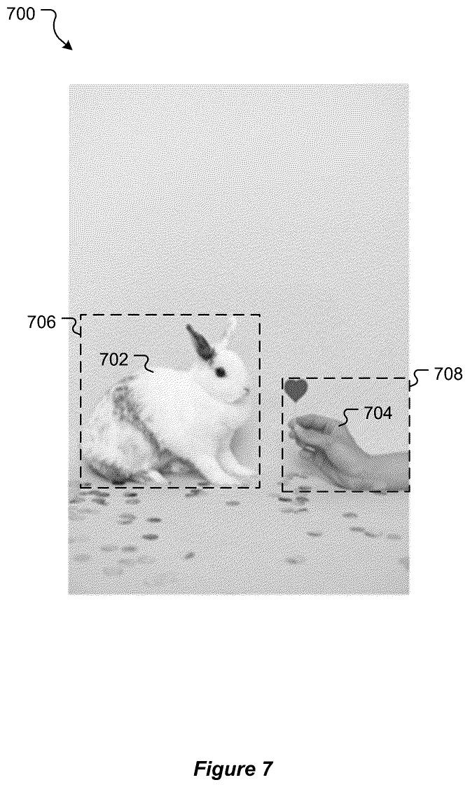

UI 300 includes an image preview area 302. Image preview area 302 may, for example, be used to display an image 304 (or, in some cases multiple images) that is being or to be edited. In this example, preview area 302 is being used to display a preview of image 700 of FIG. 7.

In this example, UI 300 also includes a detect objects control 306 which, if activated by a user, causes application 102 to process an image (e.g. the displayed image) to detect objects within that image. This processing is described further below.

UI 300 also includes a save control 308 which, if activated by a user, causes application 102 to save image 304 in its present form. For example, if image 304 has been edited, activation of control 308 will cause the edits to image 304 to be saved, for example, in non-transitory memory 210. UI 300 also includes a zoom control 310 which a user can interact with to zoom into/out of the image currently displayed.

A user can interact with UI 300 in various ways depending on the hardware available. For example, a user may control a cursor 312 via cursor control device 224. Alternatively, if the display is a touch screen display a user may interact with UI 300 by contacts and/or gestures with the display.

Whilst not illustrated in FIG. 3, UI 300 may also facilitate other functionality. For example, UI 300 may include one or more controls to search for existing images and/or other assets that application 102 makes available to a user to assist in editing images. Different types of assets may be made available, for example visual design elements of various types (e.g. text elements, geometric shapes, charts, tables, and/or other types of design elements), media of various types (e.g. photos, vector graphics, shapes, videos, audio clips, and/or other media), design templates, design styles (e.g. defined sets of colours, font types, and/or other assets/asset parameters), and/or other assets that a user may use when editing an image.

Depending on implementation, the existing images and/or other assets may be accessed from various locations. For example, search functionality invoked by one or more search controls may cause application 102 to search for existing images and/or assets that are stored in locally accessible memory of system 100 on which application 102 executes (e.g. non-transitory memory such as 210 or other locally accessible memory), assets that are stored at a remote server (and accessed via network 110), and/or assets stored on other locally or remotely accessible devices.

As a further example, UI 300 may also include one or more image editing controls, for example controls that allow a user to perform pixel-level operations on the image or on a selected object (or set of objects) in the image. These may include, for example, controls such as cut, copy, paste, brightness adjustment, contrast adjustment, saturation adjustment, black point adjustment, highlights adjustment, shadows adjustment, and/or other image editing controls.

Once an image has been edited, application 102 may provide various options for outputting that image. For example, application 102 may provide a user with options to output an image by one or more of: saving the image to local memory of system 100 (e.g. non-transitory memory 210) which may use save control 308 (where this option may be presented to the user following interaction with save control 308); saving the image to remotely accessible memory device which may also use save control 308 (again where this option may be presented to the user following interaction with save control 308); uploading the image to a server system; printing the image to a printer (local or networked); communicating the image to another user (e.g. by email, instant message, or other electronic communication channel); publishing the image to a social media platform or other service (e.g. by sending the image to a third party server system with appropriate API commands to publish the image); and/or by other output means.

Where application 102 operates to display controls, interfaces, or other objects, application 102 does so via one or more displays that are connected to (or integral with) system 100—e.g. display 218. Where application 102 operates to receive or detect user input, such input is provided via one or more input devices that are connected to (or integral with) system 100—e.g. a touch screen, a touch screen display 218, a cursor control device 224, a keyboard 226, a microphone device 222, and/or an alternative input device.

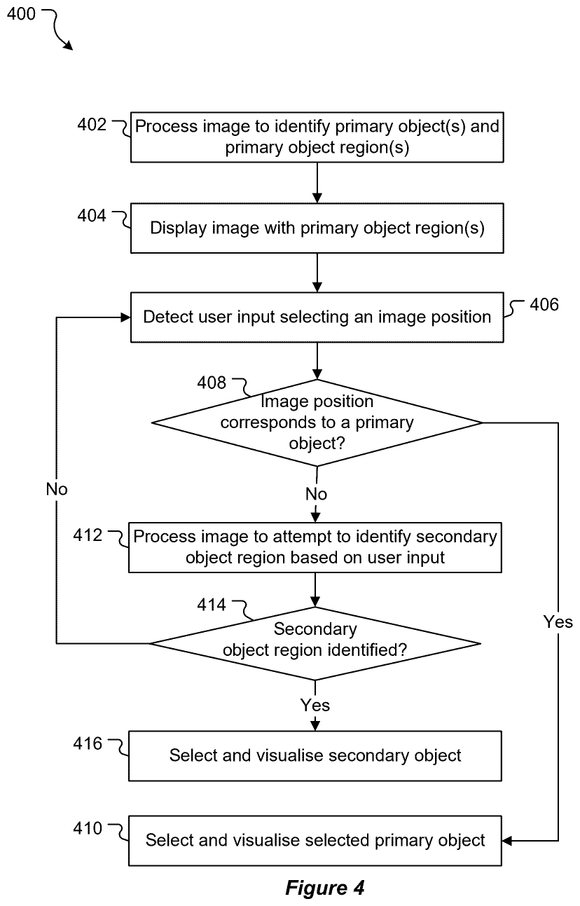

Turning to FIG. 4, a computer implemented method 400 for identifying and selecting objects in an image will be described. The operations of method 400 will be described as being performed by application 102, including co-ordinating processing by modules 104, 106 and 108, running on system 100. In alternative embodiments, however, the processing described may be performed by one or more alternative applications or modules running on system 100 and/or other computer processing systems.

Method 400 is carried out on an image. Thus, a pre-step of method 400 is the selection of an image for processing. This input may be provided, for example, by way of the user selecting an image for processing via a UI 300 (or an alternative UI). In the present embodiments, once a user has selected an image it is displayed in image preview area 302. For instance, the image may be a photograph, e.g. image 700. As mentioned above, the image is a raster image. In certain embodiments, application 102 may allow a user to select a non-raster image to be processed according to method 400 (e.g. a vector graphic), however in this case application 102 will rasterise the non-raster image before processing it according to method 400.

Application 102 may be configured to perform method 400 (or certain operations thereof) at various times. For example, application 102 may be configured to perform method 400 on demand—for example in response to a request to perform method 400. Such a request may, for example, be generated based on a user interacting with UI 300, such as interacting with detect objects control 306, which initiates method 400. In this case method 400 may be performed on an image currently displayed in image preview area 302. Alternatively, if no image is currently displayed, activation of control 306 may cause application 102 to display an image selection user interface via which a user can search or browse for, and select, an image. Application 102 may also, or alternatively, be configured to automatically perform method 400 (or certain operations thereof, such as 402 and 404). As one example, when an image is displayed in image preview area 302 application 102 may automatically perform operation 402 so primary objects have already been identified if a user activates a detect objects control such as 306.

At 402, application 102 processes the input image to identify what will be referred to as primary objects (and corresponding precise primary object regions) in the image.

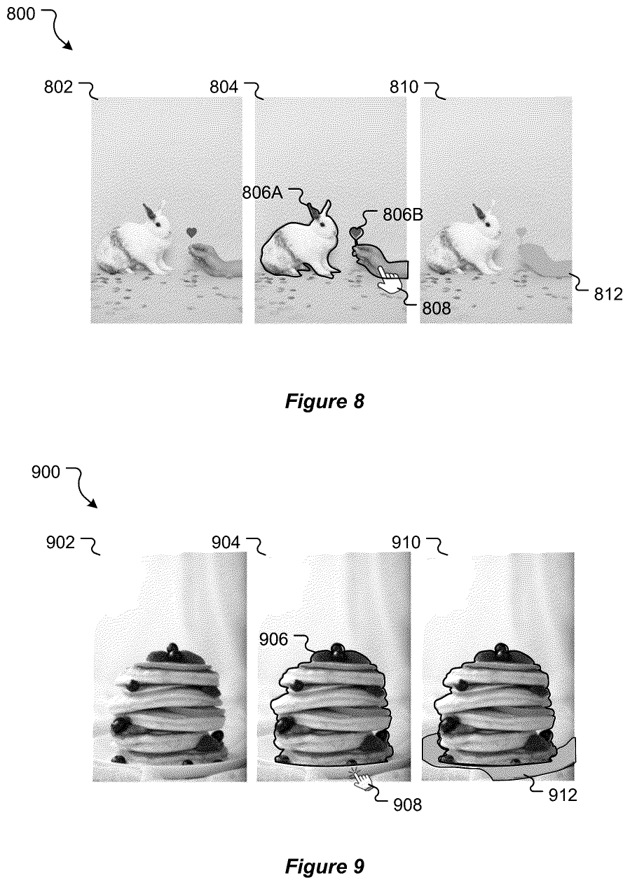

In the present context, a primary object is an object in an image that is automatically identified at 402 without a user having to manually select pixels or regions of the input image to assist in the identification process. Primary objects will typically correspond to known and relatively common types (or classes) of objects, and/or objects that are more visually dominant, such as larger objects, objects in the foreground, objects with higher resolution, and/or objects with distinct features that make them stand out in the image. By way of example, and with reference to the example images depicted in FIGS. 8 and 9, primary objects may include objects such as a rabbit, a human hand, a stack of pancakes.

The types of primary objects that are identified at 402 will depend on the approach used to identify primary objects. For example, where a trained machine learning model is used to identify primary object regions, training data used to train the machine learning model will determine the types of primary objects that can be identified. In certain embodiments, the approach used to identify primary objects may focus on a certain class or classes of objects (which will be described in detail further below).

Each primary object that is identified will correspond to (or be defined by) a precise primary object region (which will be referred to as a primary object region for convenience). The primary object region for a primary object is a precise area of the image that the primary object occupies. In the present embodiments, each primary object region is defined by a mask. Such a mask will include a set of pixels that correspond to pixels of the input image and each mask pixel will take a value that indicates whether the corresponding image pixel is part of a detected (e.g. primary) object or not. By way of a more specific example, each primary object region may be defined by a segmentation mask (e.g. a binary segmentation mask).

In the present disclosure, a precise object region (such as a primary object region identified at 402 or a secondary object region identified at 412 and discussed below) is defined by data (such as a mask) that provides a precise indication of the region of an image that an object occupies. A precise object region may be contrasted with a bounding box which defines a rectangle (e.g. by a set of (x, y, width, height) or (min x, max x, min y, max y) values) that an object is generally located in. For clarity, therefore, in the present disclosure a bounding box is different to, and does not define, a primary or secondary object region.

Application 102 may be configured to identify primary objects and primary object regions at 402 in various ways. As one example, application 102 may be configured to identify primary objects (and their corresponding primary object regions) according to method 500 described below.

In the present embodiment, if no primary object is identified in the image at 402, processing may proceed to 406. In this case, application 102 may also generate and display a message that indicates no primary objects have been identified but that the user can select a point in the image to try and have a secondary object (discussed below) identified. In other embodiments, however, if no primary object is identified method 400 may end (with application 102 optionally configured to generate and display a message to a user (e.g. via UI 300) indicating that no objects were detected in the image).

At 404, application 102 displays any primary objects that have been identified at 402 in the image (or, specifically, any primary object regions), for example in image preview area 302. Any primary objects that have been identified are displayed in a manner that visually distinguishes them from the image itself.

Application 102 visualises any primary objects based on the data representing the primary object regions that is generated at 402 (e.g. segmentation masks or other data that identifies primary object regions in the image). Using this data, application 102 may be configured to visualise a given primary object region in various ways. For example, application 102 may generate and display an overlay corresponding to each primary object region. Such an overlay may take any form that serves to visually distinguish the primary object region from the image itself. This may include, for example, the use of an outline (which may have a particular colour), shading (e.g. a partially transparent fill of a particular colour and/or pattern), a flashing overlay (e.g. an opaque or partially transparent fill that flashes), and/or an alternative visualisation of the primary object region.

Referring to FIGS. 8 and 9, two examples of images shown at various stages as displayed to a user are illustrated. Images 802 and 902 are examples of an initial input image prior to any processing. Images 804 and 904 show images 802 and 902 following step 404. In FIG. 8, two identified primary objects are visualised by use of an outline: primary object 806A (a rabbit) and primary object 806B (a human hand). In FIG. 9, a single primary object 906 (a stack of pancakes) is visualised (again by use of an outline).

At 406, application 102 detects user input selecting an image position. The selected position will be referred to as the image input position. Various user inputs selecting an image input position are possible. For example, the user input may involve activation of a cursor control device 224 (e.g. a mouse click) after positioning a cursor 312 is at a desired location on the image. In embodiments where a touch screen is used, a user may select an image position by contacting the touch screen at the desired position on the image.

At 408, application 102 determines whether the image input position selected at 406 corresponds to a primary object that has been identified in the image or not. This determination is made by comparing the image input position with the primary object regions identified at 402. In certain embodiments, application 102 is configured to determine that the image input position corresponds to a primary object if the input position is within a primary object region. In other embodiments, application 102 is configured to determine that the image input position corresponds to a primary object if the input position is within a threshold distance of a primary object region. This threshold distance may be a predefined constant distance, for example, 1 to 5 pixels or an alternative constant distance. Alternatively, the threshold distance may be calculated based on one or more variables (e.g. the size of the input image, the size of the primary object region(s) the input position is closest to, and/or other variables).

If application 102 determines that the image input position corresponds to a primary object processing proceeds to 410. At 410, application 102 selects the primary object that corresponds to the input image position (i.e. the primary object corresponding to the primary object region that the input image position corresponds to) and visualises the selected primary object. Application may use any appropriate technique to visualise the selected primary object, for example one of the techniques described at 404 above or an alternative technique.

As will be appreciated, at 410 application 102 has performed two distinct operations that involve visualising primary objects: operation 404 (where primary objects that have been detected are visualised) and operation 410 (where a selected primary object is visualised). In some instances, multiple primary objects may be identified at 402. In this case, application 102 may be configured to not only visually distinguish a selected primary object from the underlying image, but also visually distinguish the selected primary object from one or more other (non-selected) primary objects. In this case, application 102 may be configured to visualise primary object(s) identified in the image at 402 using a first visualisation technique and visualise a selected primary object at 402 using a second (and different) visualisation technique. For example, the first visualisation technique may involve the use of an outline only while the second visualisation technique may involve the use of shading. As an alternative example, the first visualisation technique may involve the use of shading of a first colour (e.g. yellow shading) while the second visualisation technique may involve the use of shading of a different second colour (e.g. blue shading).

Referring to FIG. 8, there is illustrated an example of what may be displayed at 410 following selection of a primary object. As described above, image 804 shows primary objects 806A and 806B that have been identified in image 802 and visualised (at 404) using an outline (e.g. a first visualisation technique). Image 804 is shown with a cursor 808 that is at a location corresponding to primary object 806B. In this example, the user selects the present illustrated cursor location on the image as the image input position (e.g. by a mouse click). Image 810 shows image 804 after the image input position is determined to correspond to primary object 806B (at 408 of method 400). As shown in image 810, primary object 806B is visualised as a selected primary object 812 by opaque blue shading (e.g. a second visualisation technique). In example image 810, following selection of primary object 806B, application 102 has ceased visualising the non-selected primary object 806A. In alternative embodiments, however, application 102 may continue visualising any non-selected primary objects following selection and visualisation of a particular primary object at 410. For example, and continuing with the example of FIG. 8, in image 810 application 102 could maintain the outline around the primary object 806A (the rabbit). In this case a user could continue to see—and distinguish between—the selected primary object (indicated here by blue opaque shading) and each non-selected primary object (indicated by an outline).

In certain embodiments, 404 may be omitted, and the primary objects and/or regions may not be displayed with additional visualisation technique(s) to the user. In some such embodiments, a primary object may simply be selected if the user selects an image input position that corresponds to that primary object region. In this case, the user experience of selecting a primary object may mirror that of selecting a secondary object (which will be described below in detail). In other embodiments, a primary object region will be displayed with one or more visualisation techniques (e.g., outline, shading, etc.) to the user if the user's cursor hovers over or selects an image input position that corresponds to that primary object region.

If, at 408, application 102 determines that the image input position does not correspond to a primary object, processing proceeds to 412. At 412, application 102 processes the image to attempt to identify what will be referred to herein as a precise secondary object region (or simply secondary object region for convenience) based on the image input position.

In the present context, a secondary object region corresponds to a secondary object. A secondary object region (and corresponding secondary object) is an object region (and object) that is not identified as a primary object at 402 but is identified at 412 based on the user input that selects an image input position.

In some instances, the processing performed at 402 to identify primary objects will not result in all objects in an image being identified. For example, there may be one or more other objects in the image that are discernible to the user but that are not identified as primary objects at 402. An object that is present in an image may not be identified in the processing performed at 402 for a variety of reasons. For example, an object may be a type of object that the object detector used at 402 has not been trained to identify (or an object that the detector has been trained to identify but that has not been included in a defined set of object classes that are to be identified). As another example, even if an object is a type of object that the object detector used at 402 has been trained to identify (and is in a list of object classes that are to be identified), the primary object detection process may nonetheless fail to identify an object of that type in a particular image (e.g. due to the image only including an obscured or partial view of the object or for other reasons). By way of example, image 904 of FIG. 9 depicts an image in which a stack of pancakes 906 has been identified as a primary object (at 402) but a plate on which the pancakes rest has not been identified as a primary object. This may be due to the object detection process used at 402 not being trained or configured to detect “plate” type objects, due to the plate in image 904 being largely occluded by the pancakes themselves, or due to another reason.

Various approaches may be used to identify a secondary object region (and, accordingly, a corresponding secondary object). As one example, application 102 may be configured to identify a secondary object region according to method 600 described below. In the present embodiment, if a secondary object region is identified at 412 data defining that region is returned. A secondary object region may be defined in the same way that a primary object region is defined (for example by a segmentation mask as described above with reference to 402) or in an alternative way.

In the present embodiment, and as indicated at 414, if no secondary object region is identified at 412 processing returns to 406 (to await a further user input that selects an image position). In this case application 102 may, though need not, be configured to generate and display a message indicating that no object could be identified based on the position selected by the user. If a secondary object region is identified processing proceeds to 416.

At 416, application 102 selects and displays the image including the secondary object (or, specifically, the secondary object region) identified at 412, for example in image preview area 302. The secondary object will be visualised to the user, i.e. displayed in a manner that visually distinguishes the selected secondary object region from the image itself. In the present embodiment, application 102 is configured to visualise a secondary object region in the same way it is configured to visualise a selected primary object at 410 (for example by use of a second visualisation technique such as shading). In alternative embodiments, application 102 may be configured to visualise a secondary object region using a third visualisation technique that is different to both the first and second visualisation techniques described above.

In present embodiments, a secondary object region is both identified and automatically selected based on the image input position selected at 406. This is in contrast to a primary object region where identification is determined prior to the image input position being selected, and then selection is based on the image input position selected at 406. In alternate embodiments, selecting a secondary object region may be based on a further selected (i.e. second) image input position being within that secondary object region, or other techniques.

Referring again to FIG. 9, there is illustrated an example of what may be displayed when a secondary object is selected and visualised at 416. As described above, image 904 shows a primary object (a stack of pancakes) highlighted by an outline of its primary object region. Image 904 is shown with a cursor 908 that is at a location that does correspond to primary object 906. Image 910 shows image 904 after the user selects the cursor location indicated in image 904 as the image input position (e.g. by a mouse click). In this case, application 102: determines that the image input position does not correspond to a primary object at 408; identifies a secondary object region 912 (a plate) at 412; and visualises the secondary object region at 416 (in this case by fully shading the secondary object region, here using a solid (non-transparent) blue fill).

Once a primary object region has been selected at 410 or a secondary object region has been selected at 414, various downstream processing may be performed. Such downstream processing may be carried out or enabled by application 102. However, in some embodiments, application 102 may communicate with one or more additional applications that may provide various downstream processing. Downstream processing may include a variety of editing functions that edit one or more selected primary object regions and/or secondary object regions. Example of such editing functions include: cutting an object (that is, removing the object to selectively be pasted), copying an object, resizing an object, applying or adjusting an image effect of the object (such as a burn effect, dodge effect, brightness effect, contrast effect, saturation effect, or any other effect that can be applied to a set of pixels of an image).

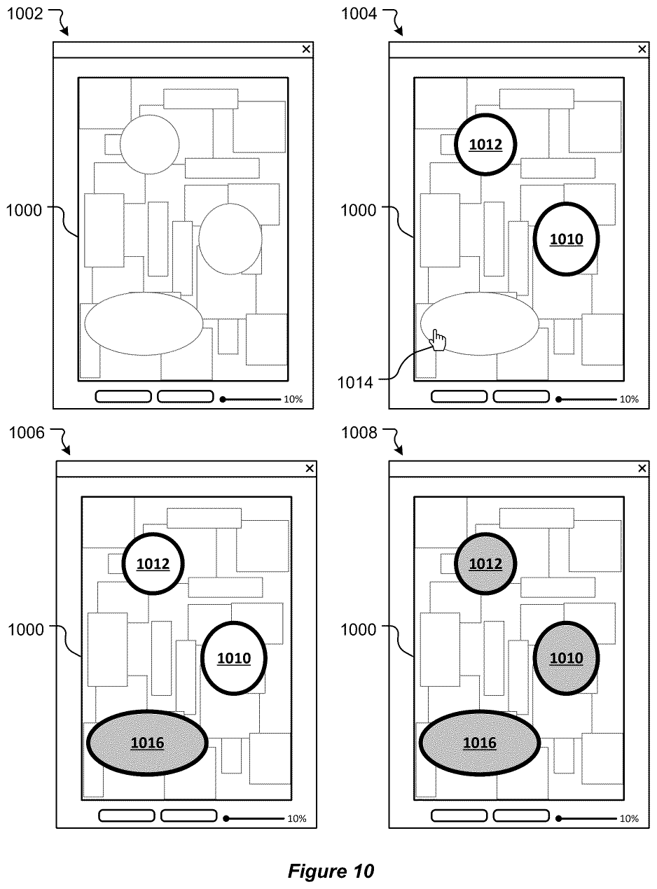

In some embodiments, the processing of method 400 may be adapted to permit a user to select any number of identified primary objects and/or secondary objects. This example will be described with reference to FIG. 10 which depicts an image 1000 and four user interface examples 1002, 1004, 1006, and 1008 (each UI example being based on the example UI 300 of FIG. 3). In the first example 1002, image 1000 is displayed in an original form. At 402 image 1000 is processed and application 102 identifies two primary objects (and primary object regions) 1010 and 1012. At 404, application 102 visualises the two primary object, in this example by use of an outline as shown in the second example 1004. Following this, a user may select an image input position 1014 (as shown in the second example 1004). This user input leads to application 102 identifying and selecting a secondary object region 1016 at 412 and, as depicted in the third example 1006, visualising that secondary object region at 416 e.g. by use of a second (alternative) visualisation technique. This is depicted in example 1006 where the visualisation technique used to distinguish selected secondary object is shading. Following this, a user may select the other objects that have been identified—for example by clicking on or contacting primary object 1008 and primary object 1010. In response, application 102 selects those two objects and updates the user interface to indicate they have been selected—e.g. by use of the second (alternative) visualisation technique, such that all of primary objects 1008 and 1010 and secondary object region 1016 are simultaneously selected. Once multiple objects are simultaneously selected in such a manner, downstream editing operations or other processing may be performed on all selected objects.

Once a primary object or a secondary object is selected, the user may also wish to de-select the object. In this case, application 102 detects user input at an image position of an already selected primary or secondary object. For example, the user input may be the user interacting with UI 300 using cursor 312 controlled via cursor control device 224. The user selects the image position by activating cursor control device 224 (e.g. a mouse click) when cursor 312 is at a desired position on the image where the selected primary or secondary object is located. This selection of the image position of an already selected primary or secondary object results in that primary or secondary object being de-selected. In embodiments where a touch screen is used, the user selects the image position by contacting the touch screen at a desired location on the image where the already selected primary or secondary object is located so as to de-select that primary or secondary object.

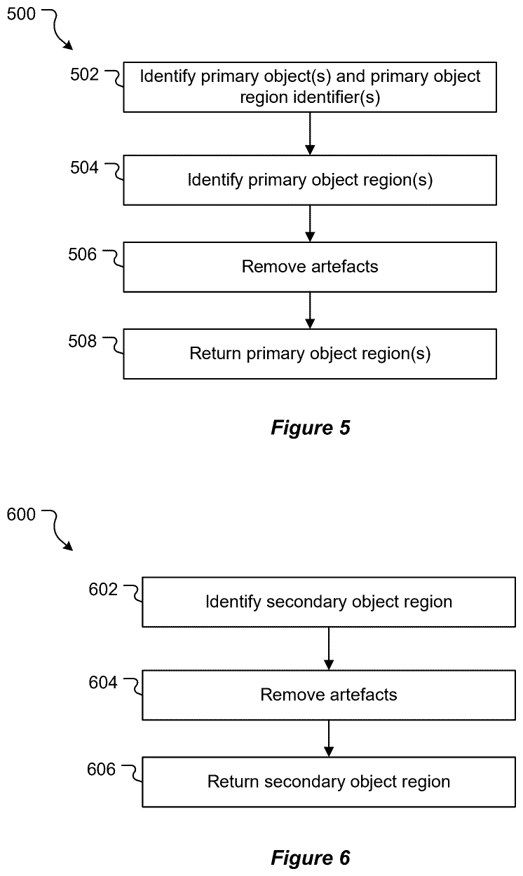

Turning to FIG. 5, a method 500 for processing an image to identify primary object(s) and corresponding primary object region(s) will be described. Method 500 may, for example, be performed by application 102 at step 402 of method 400. Method 500 may, however, be performed by application 102 (or any other application) in other contexts where objects (and object regions) need to be identified in an image.

In the present context, method 500 takes as an input an image (e.g. the image of method 400).

At 502, object detection module 104 (coordinated by application 102) processes the input image to detect objects (which, in the context of method 400, are primary objects) and corresponding primary object region identifiers. As described above, in the present embodiments the object detection module 104 uses YOLO-V6 COCO trained object detection model (though alternative object detection modules may be used).

In certain embodiments, the identification of primary objects at 502 may be performed using a specified set of object classes. For example, and as noted above, a YOLO-V6 COCO trained model is trained to identify objects in 80 different classes of common objects. In certain contexts, however, not all object classes will be relevant, and the operation of the system can be improved by performing object detection with a specified set of classes. For example, where the object detector used is a YOLO model, the ‘-- classes’ argument can be used to specify which classes the model is to detect/identify. In certain contexts, performing object detection using a specified set of classes (the specified set of classes being a subset of the classes that the object detection model is trained to detect) may reduce processing time and/or may increase the accuracy of object detection, whilst also focusing on detecting object more appropriate for the context in which object detection is being performed.

Where the identification of primary objects at 502 is performed using a specified set of object classes those classes may be predefined. Alternatively, application 102 may be configured to provide a class selection user interface prior to identifying primary objects that allows a user to define the specified set of classes by selecting (and/or de-selecting) classes or groups of classes from those available. A class selection user interface may, for example, provide a complete list of classes that the object detector can detect and allow users to select/deselect classes from that list. As a further example, a class selection user may also (or alternatively) provide certain class themes for a user to select or de-select, with each class theme being associated with one or more classes. As one specific example, a “city” class theme may be provided which is that includes object classes such as “car”, “truck”, “road”, “traffic light” (and other classes of objects that may commonly occur in a city) but excludes object classes such as “horse”, “cow”, giraffe” (and other classes of objects that would not typically be found in a city).

The object detector receives the input image (and, if relevant, a specified set of object classes). Based on these, the object detector identifies objects in the image. For each object identified, the object detector returns object data that will include a region identifier (also referred to as a selected region identifier) that identifies a general region of the image in which the detected object is located. The specific object data that is returned will depend on the object detector used. For example, a YOLO object detector will return object data that may include one or more potential region identifiers for each object that is detected, i.e. YOLO object detector may return multiple potential region identifiers for a single detected object. Each of those one or more potential region identifiers includes a bounding box data (e.g. a set of four x, y coordinate values defining the four corners of a rectangle that encompasses the identified object, or alternative to four coordinate values one set of x, y coordinate values along with width and height values that define the rectangle). The object data also includes, for each of the one or more potential region identifiers, class probability data (e.g. data indicating a probability that the object belongs to a particular class, also referred to as a confidence score). Where the object detector returns such class probability data, object detection module 104 is configured to select a region identifier from the one or more potential region identifiers. This selection may be based on class probability data of each of the one or more potential region identifiers. For example, the selection may be based on the confidence score of each potential region identifier, such that the selected region identifier is the potential region identifier with the highest confidence score. In some embodiments, object detection module 104 may also be configured to require a threshold probability value (i.e. a threshold confidence score) to treat an object that has been detected by the object detector as a valid primary object. Such a threshold confidence score may be, for example, 35%. In other embodiments, the threshold confidence may be 50%. In other embodiments, the object detector may return the selected region identifier only. In yet other embodiments, other techniques may be used to select the region identifier from the one or more potential region identifiers.

To illustrate the above, and referring to FIG. 7, image 700 includes two objects: 702 (a rabbit) and 704 (a human hand). Objects 702 and 704 may be detected by the object detector as primary objects. Based on this detection, the object detector returns bounding boxes (i.e. primary object region identifiers that are selected from respective one or more potential region identifiers for each primary object) which are shown on image 700 for illustrative purposes (i.e. these may not be displayed to a user), these bounding boxes having references 706 and 708 (that correspond to objects 702 and 704, respectively).

In some embodiments, following the identification of primary objects (and their bounding boxes) at 502, application 102 processes the primary objects to identify and remove what will be referred to large objects. This processing may be performed by the artefact removal module 108. In these embodiments, the artefact removal module 108 processes each primary object identified at 502 to determine if it is a large object. In the present example, an object will be a large object if its bounding box exceeds a threshold size. The threshold size may, for example, be defined as a percentage of the total image size. In one implementation, the threshold size is 85%. That is, if the size of a primary object bounding box is greater than 85% of the total image size it is determined to be a large object. Other threshold sizes may be used, for example 80%, 90%, or an alternative threshold size. In the present embodiment, if artefact removal module 108 determines that a particular primary object is a large object it removes that object (e.g. its bounding box) from further processing.

At 504, the image and the bounding box data of each primary object that has been detected at 502 is processed to identify primary object regions. In the present embodiment, primary object regions are identified by the segmentation module 106 which identifies an object region (in this context a primary object region) corresponding to each primary object.

As described above, segmentation module 106 of the present embodiments uses a trained segmentation model to generate primary object regions (or image segments) corresponding to each bounding box. In one implementation, the segmentation model is a SAM based model, for example Efficient-Vit-SAM, which generates a raw segmentation mask corresponding to the primary object in each primary object bounding box.

In the present embodiment, at 506 the primary object regions identified at 504 are processed to identify and remove certain types of artefacts. This processing is performed by the artefact removal module 108. This processing may result in one or more primary object regions being removed from the set of primary object regions and or in one or more primary object region segmentation masks being refined to more accurately identify the primary objects (and primary object regions).

Artefact removal module 108 may be configured to identify and remove various types of artefacts in the primary object regions.

For example, artefact removal module 108 may be configured to identify and remove what will be referred to as overlap artefacts. Generally speaking, an overlap artefact occurs where a pair of primary object regions identified at 504 (e.g. a pair of raw segmentation masks) are largely overlapping. This may occur, for example, where two object bounding boxes identified at 502 are overlapping, which may then cause the segmentation module 106 to generate overlapping segmentation masks (e.g. due to the segmentation module 106 determining that both bounding boxes belong to the same underlying object).

The artefact removal module 108 may be configured to determine that an overlap artefact exists if two primary object regions (e.g. two raw segmentation masks) overlap and the extent of the overlap exceeds an overlap threshold. In certain embodiments, the extent of the overlap between two overlapping segmentation masks is calculated using the intersection over union (IOU) metric. In this case an overlap threshold of 0.75 may be appropriate (though an alternative threshold may be used, for example 0.7, 0.8, 0.85, or an alternative threshold). If the extent of an overlap between two primary object regions meets or exceeds the overlap threshold, artefact removal module 108 determines that an overlap artefact exists for the two primary object regions.

In the present embodiment, if the artefact removal module 108 determines that an overlap artefact exists for two primary object regions it removes the overlap artefact by removing one of the primary object regions. In particular, artefact removal module 108 determines which of the two primary object regions is smaller and removes that primary object region. In other embodiments, however, an overlap artefact may be removed by removing the larger of the two primary object regions.

The artefact removal module 108 may also be configured to address and remove overlaps where three or more primary object regions overlap one another. This may be approached in various ways, for example by sequentially identifying and addressing individual pairs of overlapping primary object regions. For example, if first, second and third primary object regions are overlapping, artefact removal module 108 may initially consider the first and second primary object regions and, if an overlap artefact exists, address it by removing one of the object regions. Artefact removal module 108 may then determine if an overlap artefact exists between the remaining two object regions and, if so, address that overlap.

In another example, this may also be addressed by identifying all instances of overlapping primary object regions. In such examples, artefact removal module 108 may make a determination to remove one or more of the regions, for instance, based on size of the region, until no overlap exists.

By way of further example, artefact removal module 108 may also or alternatively be configured to identify and remove what will be referred to as fragment artefacts. Generally speaking, fragment artefacts occur where a primary object region identified by the segmentation model (e.g. a raw segmentation mask) includes a number of relatively small sized object regions, referred to as fragments (or sub-masks).

More specifically, artefact removal module 108 will determine that a particular object region (e.g. a raw segmentation mask) has fragment artefacts in the object region. This determination may be made by way of one or more object connectivity detection processing techniques. An example of one such technique is connected-component analysis which may determine one or more connected regions of an image. In this case, the one or more connected regions may correspond to a primary object region. Thus, if fragments are determined to be located in a single connected region (i.e. a single primary object region), then the particular object region is determined to include fragment artefacts.

If an object region has fragment artefacts, artefact removal module 108 addresses this by determining if each fragment region meets a predetermined fragment area threshold. The threshold may, for example, be taken as an area size such as an area size in pixels. In one implementation, the predetermined fragment area threshold is an area size of 625 pixels sq (e.g. 25*25). In other embodiments, the predetermined fragment area threshold may be other than 625 pixels sq, for example 600 pixels sq or 650 pixels sq. If a fragment region's area is less than the predetermined fragment area threshold, artefact removal module 108 refines the object region (e.g. the segmentation mask) to remove that fragment region. Further, artefact removal module 108 may also remove fragment regions that meet the predetermined fragment area threshold based on a predetermined total fragment threshold. That is, if the number of fragment regions that meet the predetermined fragment area threshold is greater than the predetermined total fragment threshold, artefact removal module 108 removes fragment regions such that the number of fragment regions that meet the predetermined fragment area threshold that are kept is equal to the predetermined fragment area threshold. The removal of such regions based on the predetermined fragment area threshold may be determined based on the size of the fragment regions. For instance, artefact removal module 108 may remove fragment regions such that only the largest fragment regions are kept. For example, the predetermined total fragment threshold may be three. In this case, after the fragment regions that meet the predetermined fragment area threshold are determined, artefact removal module 108 removes all but the three largest regions. In other embodiments, the predetermined total fragment threshold is other than three, for example two or four. If there are less fragment regions than the predetermined total fragment threshold, then all the fragment regions that meet the predetermined fragment area threshold are kept. Thus, artefact removal module 108 will output as the primary object region a refined object region, i.e. a refined segmentation mask, that includes at most a number of fragment regions defined by the predetermined total fragment threshold, where each of those fragment regions is at least the size defined by the predetermined fragment area threshold.

By way of further example, artefact removal module 108 may also or alternatively be configured to identify and remove what will be referred to as hole artefacts. Generally speaking, a hole artefact occurs where a primary object region identified by the segmentation model (e.g. a raw segmentation mask) includes a number of “holes” within an otherwise solid object region. In the present embodiment, if the artefact removal module 108 determines that a segmentation mask defines an object region that includes more than threshold number of holes it will determine that a hole artefact exists. In one implementation, the predetermined total hole threshold is 5 holes. In other embodiments, an alternative total hole threshold may be used, for example 4 holes, 6 holes, or an alternative number of holes.

In the present embodiment, if the number of holes in a raw segmentation mask is greater than the predetermined total hole threshold, artefact removal module 108 will fill in these holes so that the object region does not contain any holes. That is, artefact removal module 108 will output as the primary object region a refined object region, i.e. a refined segmentation mask, that does not include holes.

In other embodiments, artefact removal module 108 may be configured to identify and remove other types of artefacts in the primary object regions. For example, artefact removal module 108 may refine the boundary of the primary object region so that it more accurately defines the primary object.

At 508, application 102 returns a set of primary object regions, for example the refined segmentation masks generated at 506 (or raw segmentation masks as generated at 504 if no artefacts are identified at 506, or artefact removal is not performed).

Method 500 as described above operates to identify primary object regions via a pipeline that involves use of an object detection model at 502 (which is used to detect objects and bounding boxes corresponding thereto) and a segmentation model at 504 (which is used identify more precise object regions based on their bounding boxes). The inventors have identified that in certain contexts this combination provides for better object detection and segmentation than use of a single instance segmentation model. In other embodiments, however, 502 and 504 method 500 may be replaced by processing that uses an instance segmentation model to identify primary objects and corresponding primary object regions. Such an instance segmentation model may, for example, be a MaskDINO model (e.g. as described in the paper “Mask DINO: Towards A Unified Transformer-based Framework for Object Detection and Segmentation” by Feng Li, Hao Zhang, Huaizhe xu, Shilong Liu, Lei Zhang, Lionel M. Ni, Heung-Yeung Shum (arXiv: 2206.02777)), Mask-RCNN (e.g. as described in the paper “Mask R-CNN” by Kaiming He, Georgia Gkioxari, Piotr Dollár, Ross Girshick (arXiv: 1703.06870)), a DetectorS model (e.g. as described in the paper “DetectoRS: Detecting Objects with Recursive Feature Pyramid and Switchable Atrous Convolution” by Siyuan Qiao, Liang-Chieh Chen, Alan Yuille (arXiv: 2006.02334)), or an alternative instance segmentation model. In this case, regions identified by the instance segmentation model may be processed to remove artefacts (at 506), or artefact removal at 506 may be omitted.

Turning to FIG. 6, a method 600 for processing a region of an image to attempt to identify a secondary object region will be described. Method 600 may, for example, be performed by application 102 at step 412 of method 400, with the region image being identified by (or based on) the image position selected at 406. Method 600 may, however, be performed by application 102 (or any other application) in other contexts where attempting to identify an object region in a region of an image is needed.

Where performed at step 412 of method 400, method 600 takes as an input the initial input image of method 400 and the image input position selected at 406.

At 602, segmentation module 106 processes the input image to identify a secondary object region based on the image input position. In present case, the segmentation module 106 uses the same segmentation model that is used at 504 to attempt to identify a secondary object region (e.g. an Efficient-Vit-SAM model or alternative segmentation model). In other embodiments, the segmentation module 106 may use a different (e.g. second) segmentation model than is used at 504 to identify a secondary object region. In this case, the segmentation model identifies a secondary object region based on the image input position and generates a raw segmentation mask that defines that secondary object region.

At 604, and in the present embodiment, the secondary object region identified at 602 is processed to identify and remove certain artefacts that may be present in the region. This processing is performed by the artefact removal module 108 and may be the same as or similar to the processing described above with reference to 506 (in particular identifying and removing fragment artefacts and identifying and removing hole artefacts). Where artefact removal is performed at 604 it may result in the raw secondary object region (e.g. segmentation mask) identified at 602 being refined.

At 606, application 102 returns a secondary object region, for example a refined segmentation mask (or a raw segmentation mask as generated at 602 if no artefacts are identified at 604, or artefact removal is not performed).

The flowcharts illustrated in the figures and described above define operations in particular orders to explain various features. In some cases, the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Still further, the functionality/processing of a given flowchart operation could potentially be performed by (or in conjunction with) different applications running on the same or different computer processing systems.

The present disclosure provides various user interface examples. It will be appreciated that alternative user interfaces are possible. Such alternative user interfaces may provide the same or similar user interface features to those described and/or illustrated in different ways, provide additional user interface features to those described and/or illustrated, or omit certain user interface features that have been described and/or illustrated.

To illustrate the types of features that application 102 may provide, FIG. 3 provides an example of a user interface, UI 300. UI 300 may be one such GUI of the user interface of application 102. Application 102 may include a variety of GUIs. It will be appreciated that other GUIs may exist as part of application 102 or other applications that may facilitate the same or similar user interaction as example GUI 300.

Unless otherwise stated, the terms “include” and “comprise” (and variations thereof such as “including”, “includes”, “comprising”, “comprises”, “comprised” and the like) are used inclusively and do not exclude further features, components, integers, steps, or elements.

In some instances, the present disclosure and/or claims may use the terms “first”, “second”, etc. to identify and distinguish between elements or features. When used in this way, these terms are not used in an ordinal sense and are not intended to imply any particular order. For example, a first visualisation technique could equally be referred to a second visualisation technique without departing from the scope of the described examples. Furthermore, when used to differentiate elements or features, a second feature could exist without a first feature or a second feature could exist before a first feature.

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage or attribute that is not expressly recited in a claim should be considered as a required or essential feature. Accordingly, the specification and drawings are to be regarded in an illustrative rather than a restrictive sense.

1. A computer implemented method including:
displaying an image on a display;
processing, using one or more processing units, the image to identify one or more primary object regions in the image;
receiving a first user input selecting a first input image position;
determining that the first input image position does not correspond to any primary object region; and
in response to determining that the first input image position does not correspond to any primary object region, processing the image based on the first input image position to identify a secondary object region in the image.

2. The computer implemented method of claim 1 wherein processing the image to identify one or more primary object regions includes processing the image using an object detector to identify the one or more primary objects and one or more primary object region identifiers corresponding to the one or more primary objects.

3. The computer implemented method of claim 2, wherein the object detector is a first machine learning model.

4. The computer implemented method of claim 3, wherein:
the first machine learning model is an object detection model that is trained to identify objects in a set of object classes; and
processing the image to identify the one or more primary objects in the image includes limiting the first machine learning model so that it only identifies objects in a subset of the set of object classes.

5. The computer implemented method of claim 2, wherein processing the image to identify one or more primary object regions further includes:
processing the image and the one or more primary object region identifiers using a first segmentation model to generate the one or more primary object regions.

6. The computer implemented method of claim 1, wherein each primary object region is defined by a segmentation mask.

7. The computer implemented method of claim 1, wherein processing the image based on the first input image position to identify the secondary object region in the image includes processing the image and the first input image position using a second segmentation model.

8. The computer implemented method of claim 1, wherein the secondary object region is defined by a segmentation mask.

9. The computer implemented method of claim 1, further including processing the one or more primary object regions to remove artefacts wherein processing the one or more primary object regions to remove artefacts includes one or more of:
identifying and removing one or more fragments from a first primary object region;
identifying and filling one or more holes in the first primary object region;
identifying that the first primary object region overlaps with a second primary object region and removing the second primary object region; and
identifying and removing one or more primary object regions having a size greater than or equal to a threshold size.

10. The computer implemented method of claim 1, further including processing the secondary object region to remove artefacts wherein processing the secondary object region to remove artefacts includes one or more of:
identifying and removing one or more fragments from the secondary object region; and
identifying and filling one or more holes in the secondary object region.

11. The computer implemented method of claim 1, wherein the method further includes selecting one or more of the primary object regions and the secondary object region for downstream processing.

12. The computer implemented method of claim 1, wherein in response to determining that the first input image position corresponds to a first primary object region, the method includes:
foregoing processing the image based on the first input image position to identify the secondary object region in the image; and
selecting the first primary object region.

13. The computer implemented method of claim 1, further including:
receiving a second user input selecting a second input image position;
determining that the second input image position corresponds to a first primary object region; and
in response to determining that the second input image position corresponds to the first primary object region, selecting the first primary object region.

14. The computer implemented method of claim 1, further including visually distinguishing the one or more primary object regions using a first visualisation technique.

15. The computer implemented method of claim 14, wherein the first visualisation technique includes highlighting an outline of each of the one or more primary object regions.

16. The computer implemented method of claim 1, further including visually distinguishing the secondary object region using a second visualisation technique.

17. The computer implemented method of claim 16, wherein the second visualisation technique includes shading the secondary object region.

18. The computer implemented method of claim 1, wherein in response to the first user input the method further includes selecting the secondary object region.

19. A computer processing system including:
one or more a computer processing units;
a display;
a user input device; and
non-transitory computer-readable storage medium storing instructions, which when executed by the computer processing unit, cause the computer processing unit to perform a method according to claim 1.

20. Non-transitory storage medium storing instructions executable by one or more computer processing units to cause the one or more computer processing units to perform a method according to claim 1.
